(19) United States
(12) Patent Application Publication
(10) Pub. No.: US 2022/0117450 A1
(43) Pub. Date: Apr. 21, 2022

(54) A VACUUM CLEANER

(71) Applicant: Black & Decker, Inc., New Britain, CT (US)

(72) Inventor: Emilie LAGEAT, Bishop Auckland (GB)

(21) Appl. No.: 17/269,008

(22) PCT Filed: Jul. 25, 2019
(86) PCT No.: PCT/EP2019/070067

§ 371 Date: Feb. 17, 2021

(30) Foreign Application Priority Data
Aug. 8, 2018 (EP) 1812891.8

(51) Int. Cl. A47L 5/24; A47L 9/10; A47L 9/16; A47L 9/28; A47L 9/32

(52) U.S. Cl. CPC A47L 5/24; A47L 9/106; A47L 9/1608; A47L 9/322; A47L 9/1691; A47L 9/2884; A47L 9/165

(57) ABSTRACT

A vacuum cleaner comprises a housing. A motor-fan assembly is mounted in the housing and arranged to generate and air flow between an air inlet and an air outlet. A spiral dirt separator is mounted between the air inlet and the motor-fan assembly. A dirt collector mountable on the housing and comprising a plurality of dirt compartments arranged to each receive dirt from a different part of the spiral dirt separator.

### CROSS-REFERENCE TO RELATED APPLICATIONS

This application is a U.S. National Stage application under 35 U.S.C. 371 of PCT/EP/2019/070067, filed Jul. 25, 2019 which claims priority from Great Britain Patent Application No. 1812891.8 filed Aug. 8, 2018, the disclosure of which are incorporated herein by reference in their entirety.

### BACKGROUND OF THE INVENTION

The present invention relates to a vacuum cleaner. In particular the present invention relates to a vacuum cleaner with a spiral dust separator.

Many people use vacuum cleaners to clean and tidy their homes. Normally vacuum cleaners are used to pick up dust and debris using a negative pressure. Dust and debris is entrained in an air flow and sucked into the body of the vacuum cleaner wherein the dust and debris are separated from the air flow. Once separated from the air flow, the dust and debris are collected and usually emptied in a dustbin at the user's convenience.

There has been a trend for consumers to use cordless vacuum cleaners because they are more convenient than traditional corded vacuum cleaners when cleaning a dirty surface. Some cordless vacuum cleaners are small and light enough to be handheld vacuum cleaners which are also known has “handvacs”. Handheld vacuum cleaners are generally designed to be held in a single hand of the user when in use. Typically, a handheld vacuum cleaner is held in a wand like manner when cleaning.

Performance of handheld vacuum cleaners are often constrained by the size of the motor and the battery. This means that improvements to power and airflow of current handheld vacuum cleaners can be limited because it may be undesirable to use large heavy motors and batteries in the handheld vacuum cleaners.

One current handheld vacuum cleaner is described in WO2013/093415. This discloses a multistage cyclonic handheld vacuum cleaner. The dirty air enters the dust container tangentially to generate a cyclonic air flow. One of the problems with this handheld vacuum cleaner is that the airflow path is tortuous and requires many bends and turns between the air inlet and the air outlet. Accordingly, a high power motor is needed to generate a high air flow speed in order for the handheld vacuum cleaner to provide effective pick up of dirt and debris. This decreases the amount of cleaning that can be achieved with one charge.

U.S. Pat. No. 6,332,239 discloses a handheld vacuum cleaner with a separation screw for separating dirt entrained in the air flow. A problem with this is that dirt can be separated by the separation screw, but the air flow will readily re-entrain separated dirt into the air flow. Accordingly, a perforated shroud upstream of a filter will separate most of the dirt. This is undesirable because the perforated shroud will become easily blocked.

A dual scavenging separator is shown in U.S. Pat. No. 4,179,273 which uses a helical baffle for separating contaminants from a fluid. A problem which this arrangement is that the separator is arranging for dirt separation from a liquid. Accordingly a dirty residual liquid is directed to a separate sump.

Alternatively, another known multistage handheld vacuum cleaner which generates a cyclonic air flow is shown in U.S. Pat. No. 6,485,536. A spiral ramp is used to generate cyclonic separation with a plurality of debris openings connected to a dirt chamber. However a problem with this is that separated dirt received in the dust chamber can be re-entrained into the air flow and exit the dust container via a different debris opening.

### BRIEF SUMMARY OF THE INVENTION

Embodiments of the present invention aim to address the aforementioned problems.

According to an aspect of the present invention there is a vacuum cleaner comprising: a housing; a motor-fan assembly mounted in the housing and arranged to generate and air flow between an air inlet and an air outlet; a spiral dirt separator mounted between the air inlet and the motor-fan assembly; and a dirt collector mountable on the housing and comprising a plurality of dirt compartments arranged to each receive dirt from a different part of the spiral dirt separator.

Optionally, the plurality of compartments are isolated from each other.

Optionally, the dirt received in the dirt compartments is received tangentially from the air flow in the spiral dirt separator.

Optionally, the housing comprises a plurality of windows adjacent to the spiral dirt separator and each window is aligned with a corresponding dirt compartment.

Optionally, the dirt collector comprises a plurality of internal walls arranged to align with edges of the spiral dirt separator.

Optionally, the internal walls are integral with the dirt collector or the housing.

Optionally, the air inlet and the spiral dirt separator are integral.

Optionally, the dirt collector is mounted on an underside of the housing.

Optionally, the dirt collector is mounted on a side of the housing.

Optionally, a pre-motor filter is located downstream of the spiral dirt separator.

Optionally, the dirt collector comprises a lid or a door hinged to the housing.

Optionally, the dirt collector is removably mountable to the housing.

Optionally, the housing comprises a catch for releasing the dirt collector from the housing.

Optionally, the pitch and/or radius of the spiral dirt separator are variable along the longitudinal axis of the spiral dirt separator.

Optionally, the vacuum cleaner is a handheld vacuum cleaner.

According to another aspect of the present invention there is a vacuum cleaner comprising: a housing; a motor-fan assembly mounted in the housing and arranged to generate and air flow between an air inlet and an air outlet; a spiral dirt separator mounted between the air inlet and the motor-fan assembly arranged to generate a swirling air flow; and a battery mounted to the housing and connected to the motor-fan assembly.

Optionally, the battery is a lithium ion battery.

Optionally, the battery is removeable from the housing.

Optionally, the battery is mounted within the housing.

According to another aspect of the present invention there is a vacuum cleaner comprising: a housing; a brushless motor-fan assembly mounted in the housing and arranged to generate and air flow between an air inlet and an air outlet; a spiral dirt separator mounted between the air inlet and the motor-fan assembly to generate a swirling air flow.

According to another aspect of the present invention there is a handheld vacuum cleaner comprising: a housing; a motor-fan assembly mounted in the housing and arranged to generate and air flow between an air inlet and an air outlet; a spiral dirt separator mounted between the air inlet and the motor-fan assembly arranged to generate a swirling air flow; and a handle mounted on the housing.

Optionally, the handle is a pistol-grip handle.

Optionally, the motor-fan assembly is mounted between the handle and the spiral dirt separator.

Optionally, the handle is positioned above the motor-fan assembly.

Optionally, the handle is moveably mounted to the housing.

Optionally, the handle is pivotally mounted to the housing.

Optionally, the handle is slidable with respect to the housing.

Optionally, the air inlet is engageable with a floor extension tube.

According to another aspect of the present invention there is a vacuum cleaner comprising: a housing having a longitudinal axis; a motor-fan assembly mounted in the housing and arranged to generate and air flow between an air inlet and an air outlet, the motor having a rotation axis; a spiral dirt separator mounted between the air inlet and the motor-fan assembly arranged to generate a swirling air flow, the spiral dirt separator having a longitudinal axis; wherein the housing longitudinal axis, the motor rotation axis and the spiral dirt separator axis are substantially parallel.

Optionally, one or more of the housing longitudinal axis, the motor rotation axis and the spiral dirt separator axis are coaxial.

Optionally, an air flow path between the air inlet and the air outlet is substantially parallel to one or more of the housing longitudinal axis, the motor rotation axis and the spiral dirt separator axis.

Optionally, an axis of the air inlet and/or the air outlet are substantially parallel with the housing longitudinal axis.

Optionally, a handle is mounted on the housing and at least a first portion of the handle is in a plane which intersects the housing longitudinal axis.

Optionally, a second portion of the handle is in a plane substantially parallel to the housing longitudinal axis.

According to another aspect of the present invention there is a vacuum cleaner comprising: a housing; a motor-fan assembly mounted in the housing and arranged to generate and air flow between an air inlet and an air outlet; and a plurality of spiral dirt separators mounted between the air inlet and the motor-fan assembly.

Optionally, the plurality of spiral dirt separators is two or more spiral dirt separators.

Optionally, the plurality of spiral dirt separators are arranged in series.

Optionally, the plurality of spiral dirt separators are arranged in parallel.

Optionally, at least one spiral dirt separator is nested within another spiral dirt separator.

Optionally, the pitch, radius and/or number of turns of at least one spiral dirt separators is different from another spiral dirt separator.

According to another aspect of the present invention there is a vacuum cleaner comprising: a housing; a motor-fan assembly mounted in the housing and arranged to generate an air flow between an air inlet and an air outlet; a spiral dirt separator mounted between the air inlet and the motor-fan assembly; and a dirt collector removably mountable on the housing and comprising a plurality of isolated dirt compartments arranged to each receive dirt from a different part of the dirt separator, wherein when the dirt collector is in a closed configuration, each dirt compartment is isolated and when the dirt collector is in an open configuration, the plurality of compartments are emptiable.

Optionally, the vacuum cleaner is a handheld vacuum cleaner.

Optionally, the spiral dirt separator comprises a spiral guide surface and a separator housing, wherein an edge of the spiral guide surface contacts an inner surface of the separator housing.

### BRIEF DESCRIPTION OF THE DRAWINGS

Various other aspects and further embodiments are also described in the following detailed description and in the attached claims with reference to the accompanying drawings, in which:

FIG. 1 shows a perspective view of a handheld vacuum cleaner according to an embodiment;

FIG. 2 shows a perspective view of a handheld vacuum cleaner without a dirt container according to an embodiment;

FIG. 3 shows a cross section view of a handheld vacuum cleaner along axis A-A according to an embodiment;

FIG. 4 shows a cross section view of the handheld vacuum cleaner along line C-C according to an embodiment;

FIG. 5 shows an exploded cross section of part of the dirt separator and dust container according to an embodiment;

FIG. 6 shows a perspective view of a handheld vacuum cleaner according to an embodiment;

FIG. 7 shows a cross section view of a handheld vacuum cleaner along axis D-D according to an embodiment;

FIG. 8 shows a cross section view of the handheld vacuum cleaner along line E-E according to an embodiment;

FIG. 9 shows schematic cross section of the dirt separator according to an embodiment.

### DETAILED DESCRIPTION OF THE PREFERRED EMBODIMENTS

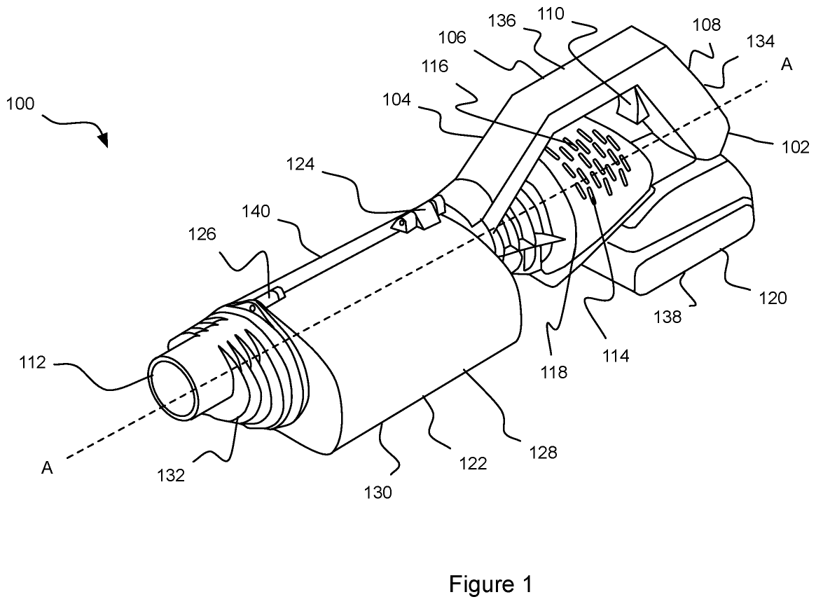

FIG. 1 shows a perspective view of a handheld vacuum cleaner 100. The handheld vacuum cleaner 100 as shown in FIG. 1 is a handheld vacuum cleaner (also known as a “handvac”), but the in other embodiments the handheld vacuum cleaner 100 may be an upright vacuum cleaner, a stickvac, a canister vacuum cleaner or any other type of vacuum cleaner. References to vacuum cleaner 100 hereinafter will be in reference to the handheld vacuum cleaner as shown in the Figures.

The handheld vacuum cleaner unit 100 comprises a housing 102. The housing 102 comprises a clam shell type construction comprises two halves which are fastened together. The halves of the housing 102 are fastened together with screws but in alternative embodiments any suitable means for fastening the housing together may be used such as glue, clips, bolts and so on. For the purposes of clarity, the fastenings in the housing 102 are not shown.

The housing 102 comprises a handle 104. The handle 104 is integral with the housing 102 and the user grips the handle 104 when operating the handheld vacuum cleaner 100. In some embodiments, the handle 104 can comprise a plurality of gripping portions 106, 108 for providing the user with different ergonomic gripping positions. FIG. 1 shows a first gripping portion 106 which is substantially parallel with a longitudinal axis A-A of the handheld vacuum cleaner 100. The handle 102 also comprises a second gripping portion 108 which extends in a plane which is not parallel with the longitudinal axis A-A. For example, FIG. 1 shows the second gripping portion 108 extending along an axis approximately 45 degrees to the longitudinal axis A-A. The second gripping portion 108 can extend in a plane which intersects the longitudinal axis A-A of the handheld vacuum cleaner 100. Additionally or alternatively, the second gripping portion 108 can extend in a plane which is substantially perpendicular to the longitudinal axis A-A of the handheld vacuum cleaner 100. The second gripping portion 108 in some embodiments may be a “pistol grip”.

Although not shown in the Figures, in some embodiments, the handle 104 is moveably mounted to the housing 102. In this way, the housing 102 comprises a pivot whereby the handle 104 is pivotally mounted to the housing 102. This means that the angle of the handle 104 with respect to the handheld vacuum cleaner 100 can be adjusted. This can make reaching awkward spaces such as under chairs or on top of cupboards easier. Additionally or alternatively, the handle 104 is slideable with respect to the housing 102. Accordingly, the handle 104 is extendable and means that the flexibility of the handheld vacuum cleaner 100 is increased. In some embodiments, the handle 104 is telescopic and is stowed within the housing 102 when not extended.

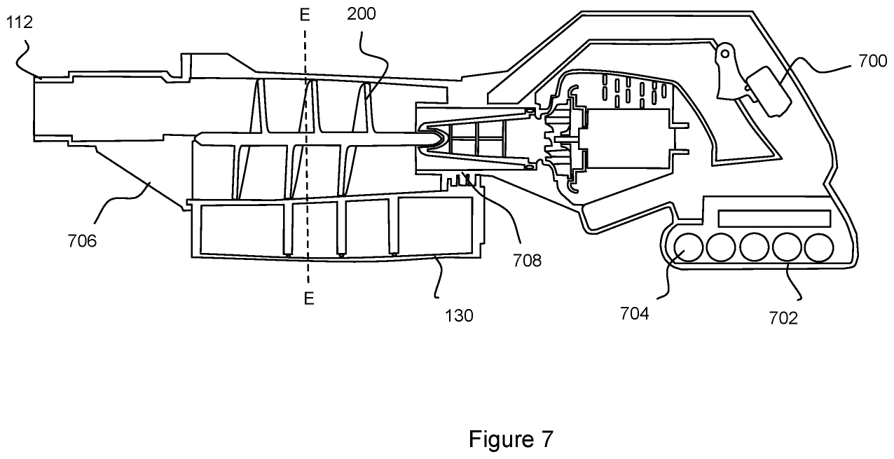

In some embodiments, the handle 104 comprises an ON/OFF switch 110 for operating the handheld vacuum cleaner 100. The switch 110 as shown in FIG. 1 is a trigger mechanism mechanically coupled to a microswitch 700 (as shown in FIG. 7). The trigger switch 110 is positioned on the underside of the second gripping portion 108 to compliment the ergonomic pistol grip. In this way, the user's index finger can be used to actuate the switch 110. In other embodiments, the ON/OFF switch 110 can be located on the top surface of the handle 104 for actuation with another digit, for example, the user's thumb. In other embodiments, the switch 110 can be located on any exterior surface of the handheld vacuum cleaner 100.

In some embodiments, the handle 104 comprises indicators for providing information about the handheld vacuum cleaner 100 to the user. A battery indicator (not shown) is mounted on the handle 104 for indicating to the user the charge level status of a battery 702 (which is best shown in FIG. 7). The battery 702 is housed in a battery housing 120. The battery housing 120 is mounted to the housing 102. In some embodiments, the battery housing 120 is integral with the housing 102. In other embodiments, the battery housing 120 and the battery 702 is releasably mountable to the housing 102. In this way, the battery 702 can be switched with another battery. The battery 702 comprises one or more sockets (not shown) for charging the battery. Further indicators (not shown) such as filter status indicators (filter blocked/filter cleared) can be mounted on the handle 104 or elsewhere on the housing. In other embodiments, the indicator is a symbol indicating to the user where to charge the handheld vacuum cleaner 100.

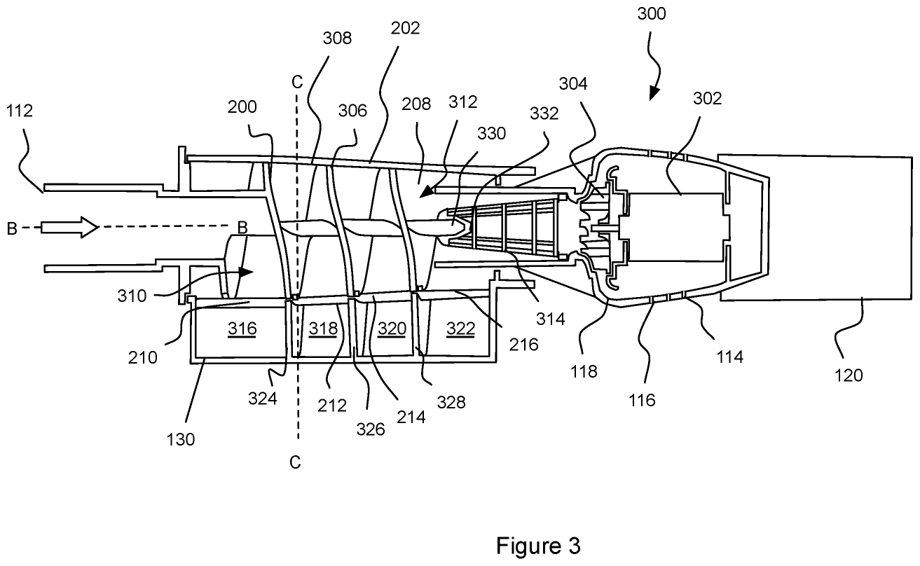

The handheld vacuum cleaner 100 comprises a generally elongate shape which extends along the longitudinal axis A-A. The housing 102 comprises a dirty air inlet 112 and a clean air outlet 114. An air flow path extends between the dirty air inlet 112 and the clean air outlet 114. The air flow path will be discussed in further detail below. The dirty air inlet 112 extends along a longitudinal axis B-B as shown in FIG. 3. The longitudinal axis of the dirty air inlet B-B 112 is substantially parallel to the longitudinal axis A-A of the handheld vacuum cleaner 100. In some embodiments the axes A-A, B-B are coaxial. In other embodiments, the axes A-A, B-B are offset from each other. The clean air outlet 114 can comprises a plurality of openings 116 which are mounted in a motor housing 118. The motor housing 118 is mounted to the housing 102. In some embodiments, the motor housing 118 is integral with the housing 102.

The openings 116 can be directed in a plurality of directions for dissipating the clean air exhaust into the environment. For example, the openings 116 can be orientated to direct the clean air away from the surface to be cleaned. This means that the dirt and debris on the surface to be cleaned is not dislodged by the exhaust clean air and blown away from the dirty air inlet 112. In some alternative embodiments (not shown), the clean air outlet 114 extends along an axis which is substantially parallel to the longitudinal axis A-A. For example, the clean air outlet 114 directs the exhaust clean air out the back of the handheld vacuum cleaner 100 on a side of the handheld vacuum cleaner 100 opposite to the dirty air inlet 112.

The handheld vacuum cleaner 100 comprises a motor fan assembly 300 which is best shown in FIG. 3. FIG. 3 shows a cross section view of the handheld vacuum cleaner 100 along axis A-A. The motor fan assembly 300 comprises a motor 302 and a fan 304 for generating a negative pressure for sucking up dirt and debris via the dirty air inlet 112. The air inlet 112 can optionally comprise a coupling engageable with a floor extension tube. This means that the handheld vacuum cleaner 100 can allow the user to extend the reach of the handheld vacuum cleaner 100.

In some embodiments, the motor 302 is a brushed d.c. motor with its drive shaft directly coupled to the centrifugal fan 304. The motor's drive shaft has a rotational speed within a range of 15,000 and 40,000 revolutions per minute (rpm). A centrifugal fan with a rotational speed within this range has an outer diameter approximately double the outer diameter of the motor can in order to have sufficient tip speed to generate the required volumetric flow rate through the separation apparatus discussed hereinafter.

In other embodiments, the motor 302 can be a d.c. motor, an a.c. motor, or an asynchronous multiphase motor controlled by an electronic circuit (not shown). A permanent magnet brushless motor, a switched reluctance motor, a flux switching motor, or other brushless motor type, may have a high rotational speed within a range of 80,000 to 120,000 rpm. When a high speed motor 302 is used, the diameter of the fan 304 can be halved and yet still generate the required volumetric flow through the separation apparatus because the fan's 304 tip speed is much higher. This makes the fan's 304 outer diameter the same as the motor can's outer diameter and could possibly make it less than the motor can's outer diameter if the motor operates at around the upper end of the high rotational speed range. A smaller diameter fan 304 operating within this range of high rotational speeds would typically be an impeller although it may be an axial fan or a centrifugal fan. The outer profile of the smaller fan coupled to the drive shaft of the high rotational speed motor would have a generally cylindrical outer profile. This provides additional flexibility in the layout of the vacuum cleaner. For example, in an embodiment (not shown), a generally cylindrical profile would allow the motor fan assembly to be orientated such that it is substantially perpendicular to the longitudinal axis A-A. This would reduce the length of the motor housing and thus reduce the overall length of the vacuum cleaner.

The motor fan assembly 300 is housed within the motor housing 118 and electrically connected to a power source. As mentioned above, the power source is a battery 702 comprising a plurality of battery cells 704. In some embodiments, the battery 702 is a lithium ion battery. In other embodiments, the battery 702 can be any suitable type of battery for use in a handheld vacuum cleaner 100. In other embodiments the handheld vacuum cleaner 100 additionally or alternatively comprises a mains electricity supply (not shown).

The rotation axis of the motor fan assembly 300 is substantially parallel to the longitudinal axis A-A of the housing 102. In some embodiments, rotation axis of the motor fan assembly 300 is coaxial with the longitudinal axis A-A of the housing 102. This “in-line” configuration allows air to be drawn into the separator in a straight line and minimises the number of bends in the air flow path. However, in other embodiments, rotation axis of the motor fan assembly 300 can be offset from the longitudinal axis of the housing 102.

In some embodiments, the motor-fan assembly 300 is mounted between the handle and the spiral dirt separator. Furthermore, the handle 104 is positioned above the motor-fan assembly 300. This makes the handheld vacuum cleaner 100 easier to handle and more ergonomic because the centre of gravity of the handheld vacuum cleaner 100 is close to the handle 104. Accordingly, there is less turning moment about the handle 104 which makes operation of the handheld vacuum cleaner 100 more comfortable. In some embodiments, the battery 702 is located at the base of the handle 104 which keeps the centre of gravity of the handle vacuum cleaner 100 close to the handle 104.

Turning back to FIG. 1, the handheld vacuum cleaner 100 will be described in further detail. A dirt container 130 is mounted on the housing 102. The dirt container 130 is arranged to receive dirt or debris which is separated from the dirty air flow received from the dirty air inlet 112 during operation.

The dirt container 130 as shown in FIG. 1 comprises an external wall 122 which forms part of the external surface of the handheld vacuum cleaner 100. The dirt container 130 comprises a portion which is releasably mountable to the housing 102. In some embodiments, the entire dirt container 130 is releasably mountable to the housing 102. In other embodiments, the dirt container 130 comprises a releasable door or lid (not shown) for emptying the dirt container 130. As shown in FIG. 1, the dirt container 130 is hinged on the housing 102. In this way, the dirt container 130 is coupled to housing 102 with a first pivot 124 and a second pivot 126. The dirt container 130 pivots with respect to the housing 102 about an axis which is parallel to the longitudinal axis A-A. This means that the dirt container 130 can be moved from a secured closed position mounted on the housing 102 to an open position. In this open position, the dirt container 130 is emptiable in a dustbin or other receptacle. The dirt container 130 is shaped such that the dirt container 130 does not interfere with the handle 104 when moved into the open position when emptying the dirt container 130.

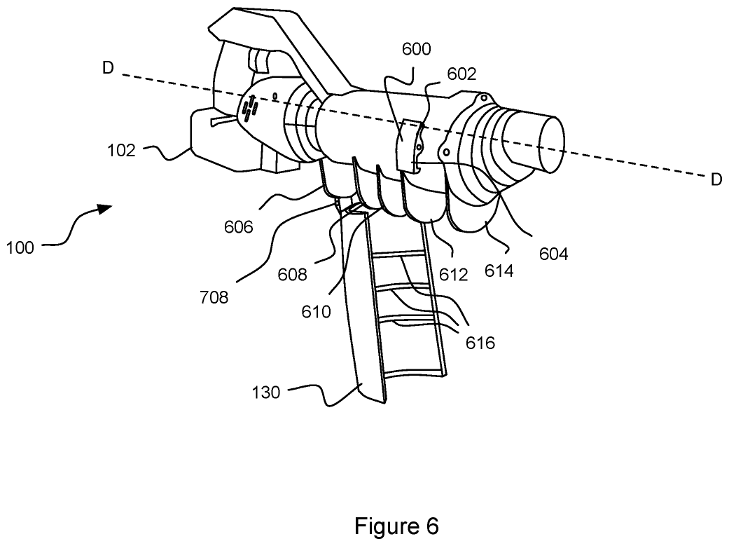

The dirt container 130 can be secured to the housing 102 with a catch mechanism (not shown in FIG. 1). In some embodiments the catch is a living hinge with a hook portion which is integral with the dirt container 130 and arranged to couple with a reciprocal recess on the housing 102. Alternatively a catch mechanism 600 can be used such as the arrangement shown in FIG. 6. The catch mechanism 600 can comprise a spring biased lever 602 which is releasable when the user depresses one end of the lever 602 and a hook portion 604 lifts up from the housing 102. In other embodiments, any other suitable mechanism can be used for selectively releasing the dirt container 130 from the housing 102. For example any arrangement of clips, clamps, hooks, latches, catches etc can be used.

In some embodiments, at least a portion of the dirt container 130 is translucent or transparent so that the user can see the status of the dirt container 130. This makes it easier for the user to know when to empty the dirt container 130. In some embodiments, the entire dirt container 130 is translucent or transparent.

In other embodiments, the dirt container 130 is releasably removeable from the housing 102 such that the dirt container 130 can be completely removed from the housing 102. This means that the dirt container 130 can be removed and washed separately from the handheld vacuum cleaner 100. For example, this allows the user to wash the dirt container 130 under a tap or in a dishwasher. When the dirt container 130 is removeable from the housing 102, the dirt container 130 can be unclipped from the first and second pivots 124, 126. Alternatively, the dirt container 130 is slidably mountable on the housing 102 and there are no pivots.

The handheld vacuum cleaner 100 inherently has a directionality in normal use. In this way, the “front” 132 of the hand handheld vacuum cleaner 100 is at the end corresponding to the dirty air inlet 112. Likewise, the “back” 134 of the handheld vacuum cleaner 100 is the end of the handheld vacuum cleaner 100 corresponding to the end with the handle 104. Accordingly, the handheld vacuum cleaner 100 has a top side 136, a bottom side 138, a first side 128 and a second side 140.

The dirt container 130 as shown in FIG. 1 is mounted on a side 128 of the housing 102. The dirt container 130 projects out from the housing 102 in the direction of the first side 128. In other embodiments, the dirt container 130 can be mounted in any position circumferentially around the longitudinal axis A-A of the handheld vacuum cleaner 100. Other mounting orientations and arrangements of dirt container 130 will be discussed with respect to the embodiments discussed in reference to FIGS. 6 to 8.

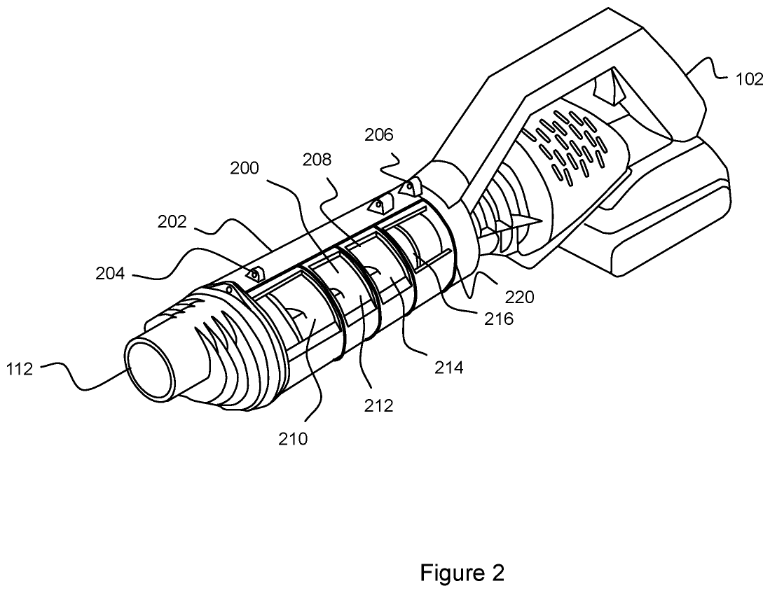

The dirt container 130 and the handheld vacuum cleaner 100 will be discussed in further detail with respect to FIG. 2. FIG. 2 shows a perspective view of a handheld vacuum cleaner 100 without the dirt container 130. FIG. 2 is the same as shown in FIG. 1, except the dirt container 130 has been removed. As mentioned previously, the dirt container 130 can be optionally removably mountable to the housing 102.

The handheld vacuum cleaner 100 comprises a dirt separator 200 for separating dirt entrained in the air flow. The dirt separator 200 is a spiral dirt separator 200. The spiral dirt separator 200 will be discussed in further detail below. The spiral dirt separator 200 is mounted in a separator housing 202. The exterior of the separator housing 202 comprises parts 204, 206 of the first and second pivots 124, 126 which are integral with the separator housing 202. The dirt collector 130 comprises reciprocal parts of the first and second pivots 124, 126. The separator housing 202 is integral with the housing 102, but in other embodiments, the separator housing 202 can be separate and mountable to the housing 102.

The separator housing 202 defines a separation chamber 208. The separation chamber 208 comprises an air flow path in fluid communication with the dirty air inlet 112 and the motor fan assembly 300. The air flow path extends substantially along the longitudinal axis A-A of the housing 102. The dirty air flows through the separation chamber 208 and separated dirt is ejected into the dirt container 130 and the clean air flows from the separation chamber 208 to the motor fan assembly 300.

The separator housing 202 comprises a plurality of windows 210, 212, 214, 216. Each of the windows 210, 212, 214, 216 is positioned along the length of separator housing 202 along the longitudinal axis A-A of the housing 102. In this way, each window 210, 212, 214, 216 is in fluid communication with a different part of the separation chamber 208. This means that dirty air flowing along the air flow path in the separation chamber 208 from the dirty air inlet 112 is sequentially in fluid communication with a first window 210, a second window 212, a third window 214, and a fourth window 216.

Optionally, the separator housing 202 comprises a single window (not shown) replacing the plurality of windows 210, 212, 214, 216. In this embodiment, the dust collector 130 comprises an internal wall (not shown) defining the windows shown in FIG. 2 when the dust collector 130 is mounted on the housing 102.

Optionally, the separator housing 202 comprises a seal 220 around the periphery of the plurality of windows 210, 212, 214, 216. The seal can be made from rubber, silicone or any other suitable material for sealing the surfaces. This provides an air tight seal between the walls of the dust collector 130 when the dust collector 130 is mounted on the housing 102. Alternatively, the dust collector 130 is pressed firmly against the separator housing 102 when the dust collector 130 is in the closed position to create a seal therebetween.

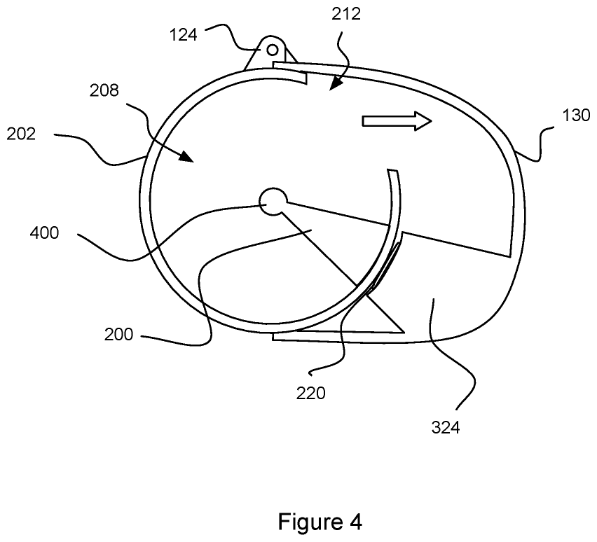

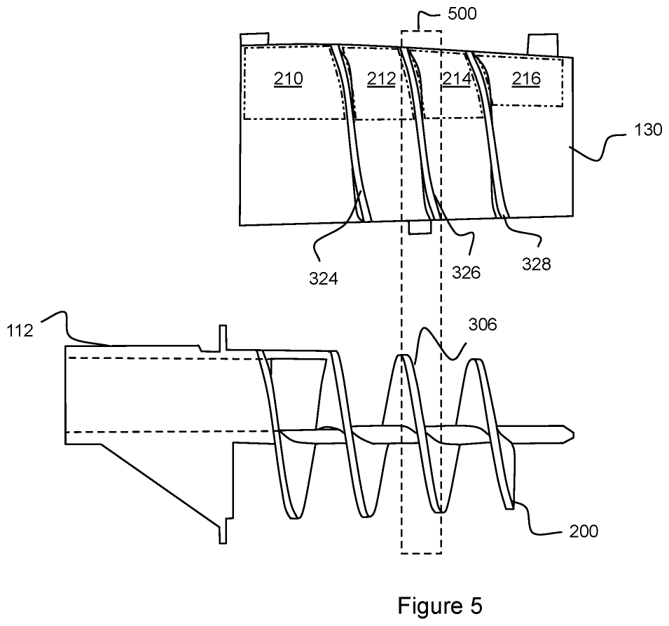

The spiral dirt collector 200 will now be described in further detail in reference to FIGS. 3, 4 and 5. FIG. 3 shows a cross section view of a handheld vacuum cleaner 100 along axis A-A. FIG. 4 shows a cross section view of the handheld vacuum cleaner 100 along line C-C. FIG. 5 shows an exploded cross section of part of the dirt separator 200 and dust container 130.

The spiral dirt separator 200 is inserted within the separator housing 202.

The spiral dirt separator 200 is coupled to the dirty air inlet 112. In some embodiments, the dirty air inlet 112 and the spiral dirt separator 200 are an integral piece. The dirty air inlet 112 and the spiral dirt separator 200 are fixed to the separator housing 202 with screws or any other suitable fastening. Since the spiral dirt separator 200 is removably mountable in the separator housing 202, the spiral dirt separator can be easily cleaned and maintained, similar to the dust collector 130 above.

The separator housing 202 tapers from the dirty air inlet 112 to the motor fan assembly 300. Accordingly, the spiral dirt separator 200 also tapers from the dirty air inlet 112 towards the motor fan assembly 300. The spiral dirt separator 200 extends along a longitudinal spiral separator axis. The spiral separator axis is substantially parallel to the longitudinal axis A-A of the housing 102. In some embodiments, the spiral separator axis is coaxial with the longitudinal axis A-A of the housing 102. However, in other embodiments, the spiral separator axis can be offset from the longitudinal axis of the housing 102. Whilst the spiral separator axis as shown in FIG. 3 is straight, in other embodiments the axis of the spiral separator can be curved and/or comprised a plurality of angled straight sections.

The spiral dirt separator 200 as shown in FIG. 3 comprises a constant number of turns along the length of the spiral separator axis. The spiral dirt separator 200 further comprises a constant pitch along the length of the spiral separator axis. That is, the angle the surface of the spiral dirt separator 200 makes with the spiral separator axis is constant along the length of the spiral separator axis. As mentioned above, the radius of the spiral dirt separator 200 reduces along the length of the spiral separator axis. However, in other embodiments the radius of the spiral dirt separator 200 is constant. In this way, the spiral dirt separator 200 can be a helical shape. Likewise, in other embodiments the pitch and the number of turns in the spiral dirt separator 200 can vary along the length of the spiral separator axis. Indeed, there can be any number of turns in the spiral dirt separator 200.

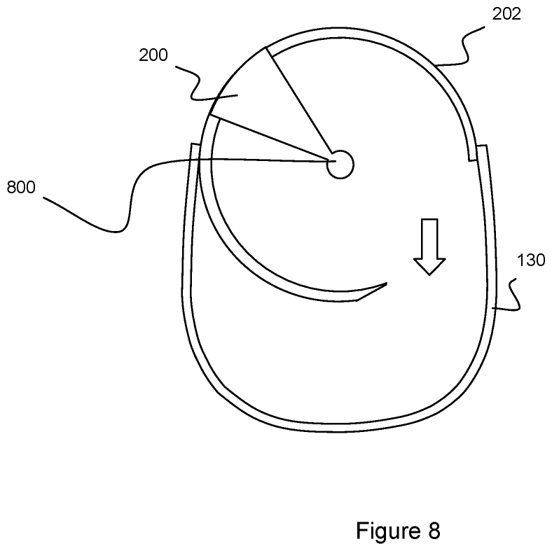

The spiral dirt separator 200 comprises an outer radius which is defined by the diameter of the separator housing 202. In addition, the spiral dirt separator 200 comprises an inner radius which is defined by the diameter of the centre 400, 800 (see FIGS. 4 and 8 respectively). In some embodiments, either the outer and/or the inner radius of the spiral can be varied. In some embodiments, the inner radius can be increased, and the outer radius decreased to create a tighter spiral air flow path for the dirty air. The tighter spiral air flow path can increase the dirt separation. In some embodiments, the spiral dirt separator 200 creates a tighter spiral air flow path in a direction along the length of the spiral separator axis towards the motor fan assembly 300. Accordingly inner radius of the centre 400 is increased and/or the outer radius is decreased in a direction along the length of the spiral separator axis towards the motor fan assembly 300. This means that the lighter, smaller particles can better removed from the dirty air flow since the dirt separation ability of the spiral dirt separator increases closer to the motor fan assembly 300.

The edge 306 of the spiral dirt separator contacts the internal surface 308 of the separator housing 202. Thus, substantially all of the air flowing between the inlet 310 and the outlet 312 follows a spiral airflow path. This improves dirt separation efficiency compared to separators that have a gap between the edge of the spiral and the inner surface of the separator housing. Such a gap leads to a direct airflow path between the inlet and the outlet and thus some of the dirty air follows a substantially straight path and does not undergo separation. Optionally, the edge 306 of the spiral dirt separator 200 can comprise a seal (not shown) for providing an air tight seal between the edge 306 of the spiral dirt separator 200 and the internal surface 308 of the separator housing 202. The seal can be made from rubber, silicone or any other suitable material for sealing the surfaces. In other embodiments, the seal is not required because the spiral dirt separator 200 forms a friction fit between the edge 306 and the internal surface 308.

The spiral dirt separator 200 comprises a spiral air inlet 310 which is in fluid communication with the dirty air inlet 112. The spiral dirt separator 200 comprises a spiral guide surface to guide air in a spiral flow. The spiral guide surface has a spiral or helicoid-like shape (e.g., like a spiral ramp or the thread of a screw). The spiral guide surface may be supported by a central support 400 that is formed at centre and along the length of the spiral dirt separator 200. The outer edge 306 of the spiral dirt separator 200 (i.e., the outer edge of the spiral guide surface) forms a helical shape. The outer edge 306 contacts the inner surface 308 of the separator housing. The spiral air inlet 310 receives the dirty air from the dirty air inlet 112 and guides the direction of the air flow from a direction parallel with the dirty air inlet axis B-B to a spiral path direction. In this way, the spiral dirt separator 200 creates a cyclonic air flow or swirling air flow.

The spiral dirt separator 200 comprises a spiral air outlet 312 in fluid communication with the motor fan assembly 300. The air flow exits the spiral dirt separator 200 and passes through a pre-motor filter 314. The pre-motor filter 314 can be a pleated fabric filter for removing small entrained particles in the air flow. The pleated fabric material is not shown for the purposes of clarity. In some embodiments, the pre-motor filter 314 can be located at any position on the air flow path before the motor fan assembly 300. The pre-motor filter 314 can be located outside the separation chamber 208 or inside the motor housing. In some embodiments, the pre-motor filter 314 can be any shape including a flat shape such as a disc, a conical shape. The pre-motor filter 314 can be pleated or non-pleated or a foam. In some embodiments, additionally or alternatively, a prefilter screen (not shown) located upstream of the pre-motor filter 314 in order to remove large items of debris such as hair. The prefilter screen can be a mesh or a screen perforated with a plurality of holes.

Optionally, A free end 330 of the spiral dirt separator 200 opposite the dirty air inlet 112 is mounted in a reciprocal recess 332 in the end of pre-motor filter 314 which projects into the separation chamber 208. This means that the spiral dirt separator 200 is held securely in place when the dirty air inlet 112 is mounted to the housing 102. The free end 330 has a push fit with the reciprocal recess 332. This means that the spiral dirt separator 200 can be removed from the pre-motor filter 314 for the purposes of cleaning and/or maintenance. In some embodiments, the free end 330 of the spiral dirt separator 200 is mountable on another component. For example, the free end 330 is mountable on ribs (not shown) projecting from the inner surface 308 of the separation chamber 208. In other embodiments, the free end 330 is unsupported. The spiral dirt separator 200 is removable for cleaning purposes.

As the dirty air flows along the spiral air flow path in the spiral dirt separator 200, the air flow experiences a centrifugal force and the entrained particles are forced towards the edge 306 of the spiral dirt separator 200. As the dirty air flows past each window 201, 212, 214, 216, dirt is flung into the dirt container 130. In this way, the separated dirt is received in the dirt collector 130 tangentially from the air flow in the spiral dirt separator 200.

The dirt container 130 comprises a plurality of dirt compartments for receiving separated dirt from the dirty air flow. The dirt container 130 comprises a first, second, third and fourth dirt compartments 316, 318, 320, 322 as shown in FIG. 2. Each of the first, second, third and fourth dirt compartments 316, 318, 320, 322 is respectively aligned with the first, second, third and fourth window 210, 212, 214, 216 in the separator housing 202.

The plurality of dirt compartments 316, 318, 320, 322 are defined by internal walls 324, 326, 328 of the dirt container 130. The internal walls 324, 326, 328 in some embodiments are integral with the dirt container 130. The seal 220 provides an air tight seal between the internal walls 324, 326, 328 and the housing 102. Accordingly each of the dirt compartments 316, 318, 320, 322 are isolated from each other. This means that the dirt compartments 316, 318, 320, 322 are not in fluid communication with each other across the internal walls 324, 326, 328. The dirt compartments 316, 318, 320, 322 will be in fluid communication with each other via the air flow path along the spiral dirt separator 200.

It has been found that the efficiency of the spiral dirt collector 200 is greatly increased if the plurality of dirt compartment 316, 318, 320, 322 are isolated from each other when the dirt collector 130 is in the closed position. This is because the air flow cannot bypass the spiral dirt separator 200 through the dirt collector 130.

In other embodiments, the internal walls 324, 326, 328 are separable from the dirt container 130. For example, optionally the internal walls 324, 326, 328 are mounted on the housing 102 and project from the surface of the housing 102.

This means that if separated dirt received in the first compartment 316 is re-entrained in to the air flow, the re-entrained dirt will still be subject to a further separation operation. This is because the entrained dirt must continue along the spiral dirt separator 200. Accordingly, even if dirt is re-entrained, the dirt will likely be separated by the spiral dirt separator 200 and caught by one of the subsequent dirt containers 318, 320, 322.

In use, most of the dirt is separated by the spiral dirt separator 200 into the first dirt compartment 316. The largest particles are separated and received in the first compartment 316 because the largest particles will experience the greatest amount of centrifugal force. Smaller particles may require travel in the spiral dirt separator 200 in order for the centrifugal force generated by the spiral dirt separator 200 to separate the smaller particles from the air flow. This means that smaller particles will generally be received by the second, third, and fourth compartments 318, 320 ,322.

In some embodiments, the volume of the first dirt compartment 316, is larger than the volume of the other dirt compartments 318, 320, 322. This is to make sure that the first dirt compartment does not fill up too quickly during use. In some embodiments the volume of the dirt compartments are progressively smaller as the dirt compartments 318, 320, 322 are located towards the motor fan assembly 300.

FIG. 3 shows four separate dirt compartments 316, 318, 320, 322. However in other embodiments, there are at least two separate compartments. For example, dirt compartments 316, 318, 320 can be combined into a single dirt compartment (not shown). In other embodiments, there can be more than two compartments, for example three, four, five etc dirt compartments. Indeed, there can be any number of dirt compartments aligned long the length of the spiral dirt separator 200.

FIG. 4 shows an arrow indicating the direction of the separating dirt having been flung in a tangential direction to the swirling air flow in the spiral dirt separator 200. Accordingly, the separated dirt travels into the second dirt compartment 318 of the dirt container 130 in the direction of the arrow. The window 212 is positioned towards the top side 136 of the handheld vacuum cleaner 100. This means that the wall of the separator housing 202 provides a labyrinthine pathway for the dirt into the dirt container 130. Accordingly, the separated dirt is less likely to be re-entrained in the air flow. Although not shown, additional internal walls and/or baffles can be provided to make the pathway between the separation chamber 208 to the dirt container 130 more circuitous.

The internal wall 324 of the dirt container 130 is shaped so that it aligns with the spiral dirt separator 200. Accordingly, the internal walls 324, 326, 328 and the spiral dirt separator 200 are part of the same spiral surface but formed in separate pieces.

This will be further explained in reference to FIG. 5. The housing 102 and other parts of the handheld vacuum cleaner 100 are not shown in FIG. 5 for the purposes of clarity. In particular, the separator housing 202 is not shown. The separator housing 202 would be positioned between the spiral dirt separator 200 and dirt collector 130. Nevertheless, the position of the windows 210, 212, 214, 216 of the separator housing 202 have been superimposed on the dirt collector 130.

The dirt collector 130 is separated from the spiral dirt separator 200 to show the internal walls 324, 326, 328 from above. Accordingly, the internal walls are formed from a partial spiral, corresponding to the spiral shape of the spiral dirt separator 200. The dotted box 500 shows how the internal wall 326 of the dirt collector 130 has a complimentary shape to the edge 306 of a portion of the spiral dirt separator 200. The windows 210, 212, 214, 216 in the separator housing 202 also comprise a shape which complements the pitch and radius of the spiral dirt separator 200. In this way the windows 210, 212, 214, 216 fit between the turns of the spiral dirt separator 200. This means that the air flow cannot skip between turns of the spiral dirt separator 200 but must flow along the entire air flow path defined by the spiral dirt collector 200.

Another embodiment will now be discussed in reference to FIG. 6. FIG. 6 shows a perspective view of a handheld vacuum cleaner 100. The handheld vacuum cleaner 100 as shown in FIG. 6 is the same as the embodiments discussed with respect to FIGS. 1 to 5. However, the handheld vacuum cleaner 100 differs in that the dirt collector 130 is mounted on the bottom side 138 of the housing 102.

Furthermore, the dirt collector 130 as shown in FIG. 6 does not have integral walls. Instead the walls 606, 608, 610, 612, 614 are mounted to the housing 102. This means that when the dirt collector 130 is in the open position, the internal walls remain fixed with respect to the housing 102. When the dirt collector 130 is in the closed position, the walls 606, 608, 610, 612, 614 and the dirt collector 130 seal against each other and define a dirt collection chamber.

In some embodiments, the dirt collector 130 comprise reciprocal sealing flanges 616 for engaging the walls 606, 608, 610, 612, 614. Additionally or alternatively, in other embodiments, one or more of the walls. 606, 608, 610, 612, 614 comprises a seal 220. By providing the seal on the walls 606, 608, 610, 612, 614, the dust collector 130 is easier to empty.

Turning to FIG. 7, the handheld vacuum cleaner 100 shown in FIG. 6 will be further explained. FIG. 7 shows a cross section view of a handheld vacuum cleaner 100 along axis D-D.

The spiral dirt separator 200 as shown in FIG. 7 the predominantly same as the embodiments as discussed in reference to FIGS. 1 to 5 and functions in the same way. The spiral dirt separator 200 differs in that the spiral dirt separator 200 is a separate element and removably mountable on the portion of the housing 706 comprising the dirty air inlet 112. By providing a removeable spiral dirt separator 200, cleaning and maintenance may be easier.

The dirt collector 130 is pivotally mounted to the housing 102 by pivot 708. In this way, the dirt collector 130 swings underneath the handheld vacuum cleaner 100 when open as shown in FIG. 6. The dirt collector 130 is secured to the housing 102 via catch 600 in the closed position which has been previously discussed in reference to FIGS. 1 to 5.

During operation, the dirt is separated from the dirty airflow using the same principle as previously discussed in reference to FIGS. 1 to 5. However, during the separation operation, the separated dirt moves tangentially downwards rather than sideways. The tangential downwards movement of the separated dirt from the spiral dirt separator 200 into the dirt collector 130 is represented by the arrow in FIG. 8. FIG. 8 shows a cross section view of the handheld vacuum cleaner 100 along line E-E. In this way. the separated dirt is collected underneath the spiral dirt separator 200.

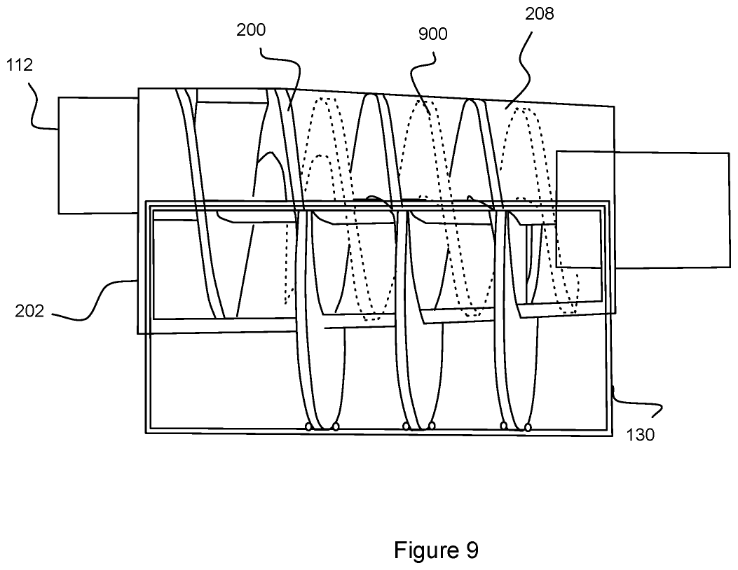

Another embodiment will be discussed in reference to FIG. 9. FIG. 9 shows schematic cross section of the spiral dirt separator 200. The spiral dirt separator 200 is the same as discussed in reference to the previous embodiments. However, in addition to the first spiral dirt separator 200 there is a second spiral dirt separator 900. The second dirt spiral dirt separator 900 is positioned between the turns of the first spiral dirt separator 200. In this way, the second spiral dirt separator 900 is nested within the first spiral dirt separator 200. Accordingly, the second spiral dirt separator 900 can increase the dirt separation because there is another parallel spiral air flow pathway in the separation chamber 208.

In other embodiments, there can be a plurality of spiral dirt separators. There can be any number of spiral dirt separators (e.g. two, three, four five etc). The plurality of spiral dirt separators can be in series and/or in parallel. For example, the second spiral dirt separator 900 can be positioned after the first spiral dirt separator 200 coaxially aligned with the spiral separator axis of the first spiral dirt separator 200. Alternatively, the second spiral separator 900 can be a parallel dirt separator and arranged adjacent to the first spiral dirt separator 200.

In some embodiments, the pitch, radius and/or number of turns of at least one of the spiral dirt separators 200 is different from another spiral dirt separator 900. This means that the spiral dirt separators 200, 900 can be tuned to remove different types, size etc of dirt and debris.

In some further embodiments which are not shown in the Figures, the centre 800 of the spiral dirt separator 200, 900 is hollow. The diameter of the centre 800 of the spiral dirt separator 200 is sufficiently large to house the motor fan assembly and/or the battery 702. In this way, the centre of the spiral dirt separator 200 is the motor housing and/or the battery housing. This can reduce the overall volume of the handheld vacuum cleaner 100.

In some additional embodiments, the spiral dirt separator 200 is coupled to a motor arranged to rotate the spiral dirt separator 200. The spiral dirt separator 200 is arranged to turn in a direction against the rotation of the air flow. This can increase the separation of the dirt from the air flow. Furthermore generating relative movement between the dirt separator spiral 200 the dust collector 130, a seal can move along the inside surface of the dust collector 130 and wipe clean the inside of the dust collector 130.

In another embodiment two or more embodiments are combined. Features of one embodiment can be combined with features of other embodiments.

Embodiments of the present invention have been discussed with particular reference to the examples illustrated. However it will be appreciated that variations and modifications may be made to the examples described within the scope of the invention.

What is claimed is:

1. A handheld vacuum cleaner comprising:
a housing;
a motor-fan assembly mounted in the housing and arranged to generate and air flow between an air inlet and an air outlet;
a spiral dirt separator mounted between the air inlet and the motor-fan assembly; and
a dirt collector mountable on the housing and comprising a plurality of dirt compartments arranged to each receive dirt from a different part of the spiral dirt separator.

2. The handheld vacuum cleaner according to claim 1 wherein the plurality of compartments are isolated from each other.

3. The handheld vacuum cleaner according to claims 1 wherein the dirt received in the dirt compartments is received tangentially from the air flow in the spiral dirt separator.

4. The handheld vacuum cleaner according to claim 1 wherein the housing comprises a plurality of windows adjacent to the spiral dirt separator and each window is aligned with a corresponding dirt compartment.

5. The handheld vacuum cleaner according to claim 1 wherein the dirt collector comprises a plurality of internal walls arranged to align with edges of the spiral dirt separator.

6. The handheld vacuum cleaner according to claim 5 wherein the internal walls are integral with the dirt collector or the housing.

7. The handheld vacuum cleaner according to claim 1 wherein the air inlet and the spiral dirt separator are integral.

8. The handheld vacuum cleaner according to claim 1 wherein the dirt collector is mounted on an underside of the housing.

9. The handheld vacuum cleaner according to claim 1, wherein the dirt collector is mounted on a side of the housing.

10. The handheld vacuum cleaner according to claim 1 wherein a pre-motor filter is located downstream of the spiral dirt separator.

11. The handheld vacuum cleaner according to claim 1 wherein the dirt collector comprises a lid or a door hinged to the housing.

12. The handheld vacuum cleaner according to claim 1 wherein the dirt collector is removably mountable to the housing.

13. The handheld vacuum cleaner according to claim 1 wherein the housing comprises a catch for releasing the dirt collector from the housing.

14. The handheld vacuum cleaner according to claim 1 wherein the pitch or radius of the spiral dirt separator are variable along the longitudinal axis of the spiral dirt separator.

15. A vacuum cleaner comprising:
a housing;
a motor-fan assembly mounted in the housing and arranged to generate and air flow between an air inlet and an air outlet;
a spiral dirt separator mounted between the air inlet and the motor-fan assembly arranged to generate a swirling air flow; and
a battery mounted to the housing and connected to the motor-fan assembly.

16. The vacuum cleaner according to claim 15 wherein the battery is a lithium ion battery.

17. The vacuum cleaner according to claim 15 wherein the battery is removeable from the housing.

18. A vacuum cleaner comprising:
a housing having a longitudinal axis;
a motor-fan assembly mounted in the housing and arranged to generate and air flow between an air inlet and an air outlet, the motor having a rotation axis;
a spiral dirt separator mounted between the air inlet and the motor-fan assembly arranged to generate a swirling air flow, the spiral dirt separator having a longitudinal axis; wherein the housing longitudinal axis, the motor rotation axis and the spiral dirt separator axis are substantially parallel.

19. The vacuum cleaner according to claim 18 wherein one or more of the housing longitudinal axis, the motor rotation axis and the spiral dirt separator axis are coaxial.

20. The vacuum cleaner according to claim 18, wherein the spiral dirt separator comprises a spiral guide surface and a separator housing, wherein an edge of the spiral guide surface contacts an inner surface of the separator housing.
